(19) United States
(12) Patent Application Publication
(10) Pub. No.: US 2019/0030900 A1
(43) Pub. Date: Jan. 31, 2019

(54) THREE-DIMENSIONAL PRINTING DEVICE

(71) Applicant: Roland DG Corporation, Hamamatsu-shi (JP)

(72) Inventor: Fumiyoshi IWASE, Hamamatsu-shi (JP)

(21) Appl. No.: 16/044,564

(22) Filed: Jul. 25, 2018

(30) Foreign Application Priority Data
Jul. 26, 2017 (JP) 2017-144096

(51) Int. Cl. B41J 2/175; B41J 2/16; B41J 2/165; B41J 11/00; B41J 29/377; B22F 3/105; B29C 64/165

(52) U.S. Cl. CPC B41J 2/175; B41J 2/1623; B41J 2/1652; B29C 64/165; B41J 29/377; B22F 3/105; B41J 11/002

(57) ABSTRACT

A three-dimensional printing device includes a receiver structured to receive a curing liquid ejected from nozzles at a receiving surface, and a detector detecting a position, on the receiving surface, of the curing liquid. A controller controls an ejection head such that inspection ejection of ejecting the curing liquid toward the receiver is performed at least before and after a three-dimensional object is printed, and causes the detector to detect a position, on the receiving surface, of the curing liquid in the inspection ejection. The controller determines whether or not each of the plurality of nozzles has an ejection abnormality, based on the position, on the receiving surface, of the curing liquid.

### CROSS REFERENCE TO RELATED APPLICATIONS

This application claims the benefit of priority to Japanese Patent Application No. 2017-144096 filed on Jul. 26, 2017. The entire contents of this application are hereby incorporated herein by reference.

### BACKGROUND OF THE INVENTION

### 1. Field of the Invention

The present invention relates to a three-dimensional printing device.

### 2. Description of the Related Art

Conventionally, a powder stack method of ejecting a binder toward a powder material and curing the powder material to print a desired three-dimensional object is known as disclosed in Japanese Patent No. 5400042.

A three-dimensional printing device disclosed in Japanese Patent No. 5400042 includes a printer portion accommodating powder, a powder supplier accommodating the powder to be supplied to the printer portion, and an inkjet head located above the printer portion. The inkjet head ejects aqueous ink toward the powder accommodated in the printer portion. More specifically, the inkjet head ejects the aqueous ink toward a portion of the powder accommodated in the printer portion, which corresponds to a cross-sectional shape of the three-dimensional object. The portion of the powder accommodated in the printer portion to which the aqueous ink is ejected is cured to form a cured layer corresponding to the cross-sectional shape. Such cured layers are sequentially stacked to print a desired three-dimensional object.

When a three-dimensional object is printed by the powder stack method, a nozzle of an ejection head may be clogged by, for example, the powder material being attached to the nozzle. In the case where the nozzle is clogged and as a result, a curing liquid is not ejected from the nozzle, a portion of the printed object to which the curing liquid is to be ejected from the nozzle is weakened. Such a reduction in the strength of the three-dimensional printed object due to such a cause is a problem especially in the case where the printed object is, for example, an artificial bone for medical use, for which safety is an important issue.

### SUMMARY OF THE INVENTION

Preferred embodiments of the present invention provide three-dimensional printing devices that guarantee that produced three-dimensional objects have high levels of strength.

A three-dimensional printing device according to a preferred embodiment of the present invention includes a printing table on which a powder material is placeable; an ejection head including a nozzle surface in which a plurality of nozzles, from which a curing liquid curing the powder material is ejected, is provided; a transporter that moves the ejection head, with respect to the printing table, to at least a first position above the printing table and a second position; a receiver including a receiving surface that faces the nozzle surface in a state where the ejection head is at the second position, the receiver being structured to receive the curing liquid ejected from the plurality of nozzles at the receiving surface; a detector that detects a position on the receiving surface of the curing liquid ejected toward the receiver from the plurality of nozzles; and a controller. The controller is configured or programmed to include a printing controller, an inspection ejector, a detection controller, and a determiner. The printing controller controls the ejection head such that the curing liquid is ejected toward the powder material on the printing table to print a three-dimensional object. The inspection ejector controls the ejection head and the transporter such that inspection ejection of ejecting the curing liquid toward the receiver is performed at least before and after the three-dimensional object is printed. The detection controller controls the detector such that the position, on the receiving surface, of the curing liquid in the inspection ejection is detected. The determiner determines whether or not each of the plurality of nozzles has an ejection abnormality, based on the position, on the receiving surface, of the curing liquid in the inspection ejection.

In the three-dimensional printing device described above, the inspection ejection is automatically performed at least before and after a three-dimensional object is printed in order to check whether or not the curing liquid is ejected normally from each of the nozzles. In the case where the curing liquid is ejected normally before and after the three-dimensional object is printed, it is confirmed that the printing is performed normally. In the case where an abnormality is detected in the inspection ejection before the printing, the printing may be stopped and necessary steps may be taken such that, for example, a maintenance work is performed on the three-dimensional printing device. In the case where an abnormality is detected in the inspection ejection after the printing, it can be determined that the printed object may have a defect such as, for example, an insufficient strength. Namely, the above-described three-dimensional printing device guarantees the strength of the three-dimensional object.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view schematically showing a three-dimensional printing device according to a preferred embodiment of the present invention.

FIG. 2 is a plan view schematically showing the three-dimensional printing device of FIG. 1.

FIG. 3 is a front view schematically showing a head unit and the vicinity thereof.

FIG. 4 is a block diagram of the three-dimensional printing device of FIG. 1.

FIG. 5 is a flowchart showing an example of printing process.

FIG. 6 is a flowchart showing steps in step S02 shown in FIG. 5.

FIG. 7 is a cross-sectional view schematically showing the three-dimensional printing device in the state where a printing tank unit is at an inspection position.

FIG. 8 is a schematic view showing an example of test pattern.

FIG. 9 is a schematic view showing an example of a structure using an optical sensor to determine whether each of nozzles is normal or abnormal.

### DETAILED DESCRIPTION OF THE PREFERRED EMBODIMENTS

Hereinafter, preferred embodiments of three-dimensional printing devices according to the present invention will be described with reference to the drawings. The preferred embodiments described below are not intended to specifically limit the present invention. Components and portions that have the same functions will bear the same reference signs, and overlapping descriptions will be omitted or simplified.

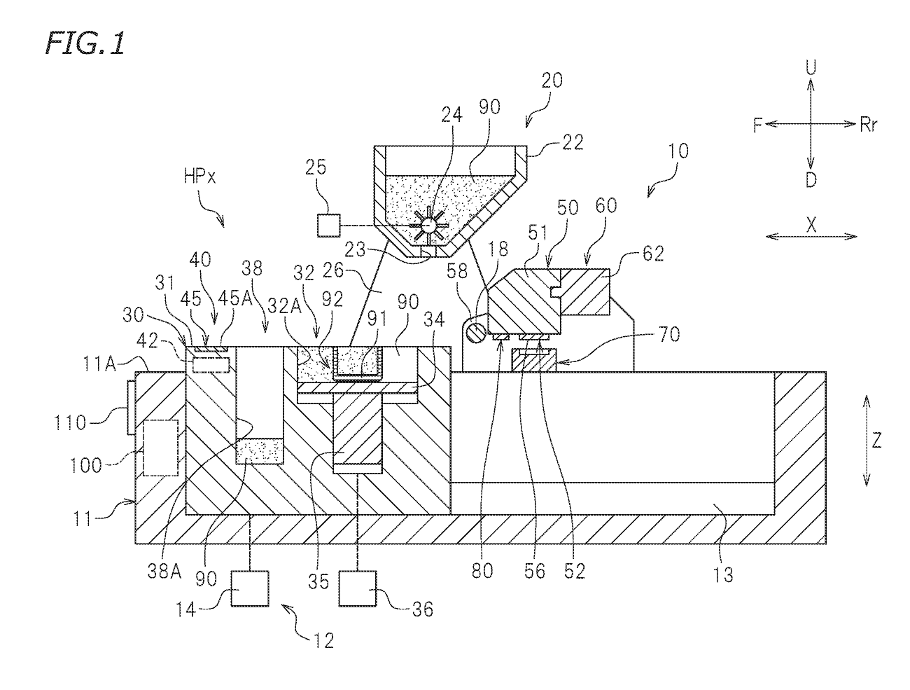

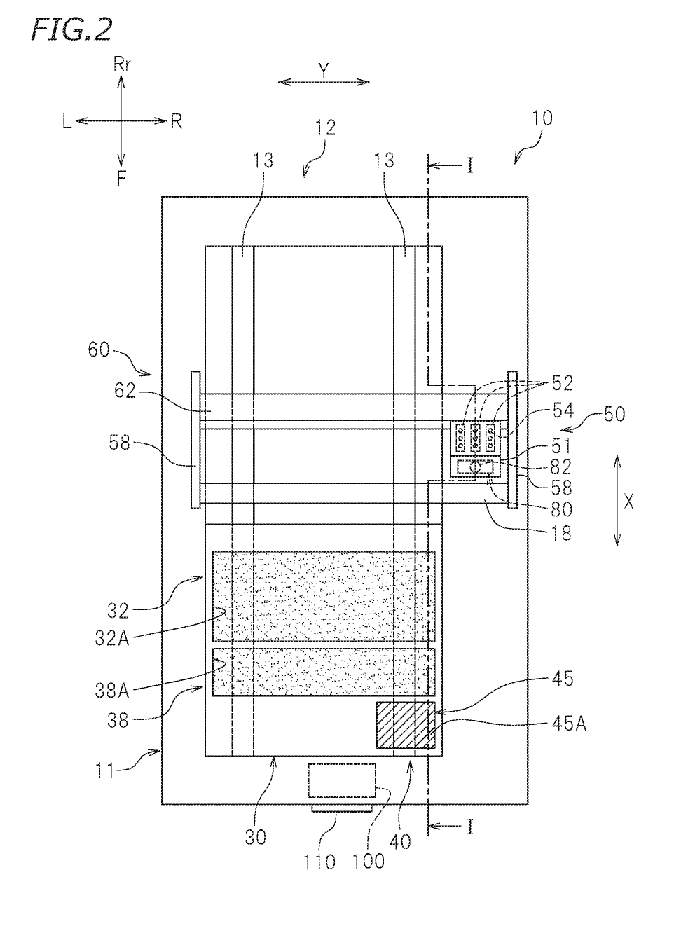

FIG. 1 is a cross-sectional view of a three-dimensional printing device 10 in this preferred embodiment. The cross-sectional view in FIG. 1 is taken along line I-I in FIG. 2. In FIG. 1, letter F represents “forward”, and letter Rr represent “rearward”. In this preferred embodiment, the terms “left”, “right”, “up” and “down” represent left, right, up and down as seen from a person who faces a front surface of the three-dimensional printing device 10. In the drawings, letters L, R, U and D respectively represent left, right, up and down. In this preferred embodiment, letters X, Y and Z respectively represent a front-rear direction, a left-right direction, and an up-down direction. The left-right direction Y is a scanning direction of the three-dimensional printing device 10. The front-rear direction X is a feeding direction of the three-dimensional printing device 10. The up-down direction Z is a stacking direction of the three-dimensional printing device 10. It should be noted that these directions are merely provided for the sake of convenience, and do not limit the form of installation of the three-dimensional printing device 10 in any way.

As shown in FIG. 1, the three-dimensional printing device 10 is a device that cures a powder material 90 with a curing liquid to form a cured layer 91 and sequentially and integrally stacks such cured layers 91 in the up-down direction Z to print a three-dimensional object 92. The three-dimensional printing device 10 in this preferred embodiment ejects the curing liquid toward the powder material 90 based on cross-sectional images representing cross-sectional shapes of the three-dimensional object 92 desired to be printed, and cures the powder material 90 to form the cured layers 91. The cured layers 91 are sequentially stacked to form the three-dimensional object 92 as desired.

Herein, the term “cross-sectional shapes” refers to shapes of cross-sections provided by slicing the three-dimensional object 92 to be printed at intervals of a predetermined thickness (e.g., at intervals of about 0.1 mm; the “predetermined thickness” is not limited to being one, same thickness) in a predetermined direction (e.g., in a horizontal direction).

There is no specific limitation on the composition, form or the like of the powder material. The powder material may be formed of any of various powder materials such as resin materials, metal materials, inorganic materials and the like. Examples of the powder material include ceramic materials such as alumina, silica, titania, zirconia and the like; iron, aluminum, titanium and alloys thereof (typically, stainless steel, titanium alloy, aluminum alloy); hemihydrate gypsum (α-calcined gypsum, β-calcined gypsum); apatite; salt; plastic materials; and the like. The powder material may be formed of one of these materials or a combination of two or more thereof.

The curing liquid is not limited to any particular liquid, and may be any liquid that fixes particles of the powder material 90 to each other. An example of curing liquid is a liquid (encompassing viscous material) that fixes the particles of the powder material. The type of curing liquid varies in accordance with the type of the powder material. Examples of the curing liquid include liquids respectively containing water, wax, binder and the like. In the case where the powder material contains a water-soluble resin as a sub material, the curing liquid may be a liquid dissolving the water-soluble resin, for example, water. There is no specific limitation on the type of the water-soluble resin. For example, the water-soluble resin may be starch, polyvinylalcohol (PVA), polyvinylpirrolidone (PVP), water-soluble acrylic resin, water-soluble urethane resin, water-soluble polyamide or the like.

As shown in FIG. 1, the three-dimensional printing device 10 includes a main body 11, a feeding direction transporter 12, a spreading roller 18, a powder supply 20, a printing tank unit 30, a head unit 50, a scanning direction transporter 60, a cleaner 70, and a controller 100.

FIG. 2 is a plan view of the three-dimensional printing device 10 in this preferred embodiment. FIG. 2 shows a state where the powder supply 20 is detached. As shown in FIG. 2, the main body 11 is an outer casing of the three-dimensional printing device 10 including a shape longer in the feeding direction X. The main body 11 has a box shape opened upward. The main body 11 accommodates the feeding direction transporter 12, the printing tank unit 30 and the controller 100. As shown in FIG. 1, the main body 11 also defines and functions as a support table that supports the spreading roller 18, the powder supply 20, the scanning direction transporter 60 and the cleaner 70.

As shown in FIG. 1, the printing tank unit 30 is accommodated in the main body 11. The printing tank unit 30 includes a printing tank 32, a printing table 34, an elevator 36, an extra powder accommodation tank 38, and an inspection stage 40. A top surface 31 of the printing tank unit 30 is flat. The printing tank 32, the extra powder accommodation tank 38 and the inspection stage 40 are provided independently side by side as being recessed from the top surface 31.

As shown in FIG. 1, the printing tank 32 is included in the printing tank unit 30. The printing tank 32 is a tank accommodating the powder material 90. The three-dimensional object 92 is printed in the printing tank 32. The printing tank 32 is provided with a printing space 32A accommodating the powder material 90. The printing space 32A is supplied with the powder material 90, so that the three-dimensional object 92 is printed in the printing space 32A.

As shown in FIG. 1, the printing table 34 is located in the printing space 32A of the printing tank 32. The powder material 90 is placeable on the printing table 34. The three-dimensional object 92 is printed on the printing table 34. The printing table 34 is movable in the up-down direction Z. The printing table 34 is, for example, rectangular or substantially rectangular as seen in a plan view. The printing table 34 is provided with a table support 35. The table support 35 extends downward from a bottom surface of the printing table 34. The table support 35 is movable in the up-down direction Z integrally with the printing table 34.

The elevator 36 moves the printing table 34 in the up-down direction Z. There is no specific limitation on the structure of the elevator 36. In this preferred embodiment, the elevator 36 includes a servo motor, a ball screw and the like (not shown). For example, the servo motor is connected with the table support 35, and is connected with the printing table 34 via the table support 35. The servo motor is driven to move the table support 35 in the up-down direction Z. Along with the movement of the table support 35 in the up-down direction Z, the printing table 34 is also moved in the up-down direction Z. The elevator 36 is electrically connected with the controller 100, and is controlled by the controller 100.

The extra powder accommodation tank 38 is a tank that, in the case where the powder material 90 supplied to the printing tank 32 is spread to fill the printing tank 32 so as to have a flat surface by the spreading roller 18, recovers a portion of the powder material 90 that is not accommodated in the printing tank 32. The extra powder accommodation tank 38 is provided with an accommodation space 38A that accommodates the powder material 90. The extra powder accommodation tank 38 is located between the printing tank 32 and the inspection stage 40 in the feeding direction X. The extra powder accommodation tank 38 is located to the front of the printing tank 32. The extra powder accommodation tank 38 is located to the rear of the inspection stage 40. The extra powder accommodation tank 38 is located at the same position with that of the printing tank 32 in the scanning direction Y. As shown in FIG. 2, as seen in a plan view, the length of the printing space 32A of the printing tank 32 in the scanning direction Y (i.e., the length of the printing table 34 in the scanning direction Y) is equal or substantially equal to the length of the accommodation space 38A of the extra powder accommodation tank 38 in the scanning direction Y. Alternatively, the length of the accommodation space 38A in the scanning direction Y may be longer than the length of the printing space 32A in the scanning direction Y.

The inspection stage 40 is a stage on which a display substrate 45 is placeable. The display substrate 45 is a plate-shaped member on which a test pattern is to be formed. The test pattern is a certain pattern formed to find an abnormality of a nozzle 54 (see FIG. 2) of an ejection head 52, and is formed of the cured liquid ejected from the ejection head 52. As shown in FIG. 2, the inspection stage 40 is located to the front of the printing tank 32 in the printing tank unit 30. The inspection stage 40 is located in the vicinity of a right corner of the printing tank unit 30.

When, for example, the curing liquid is attached to a portion of the display substrate 45 placed on the inspection stage 40, the color of the portion of the display substrate 45 is changed. The display substrate 45 is an example of “receiver”. A top surface 45A of the display substrate 45 is an example of “receiving surface”. The display substrate 45 includes a base substrate, a color layer located on the base substrate, and a blocking layer located on the color layer. The blocking layer transmits light when the curing liquid is attached to the blocking layer. The blocking layer blocks light when the curing liquid is removed from the blocking layer. A surface of the blocking layer has tiny concave and convex portions. While the curing liquid is not attached to the blocking layer, the light is reflected and thus the color layer does not appear to be colored. By contrast, while the curing liquid is attached to the blocking layer, light transmits through the blocking layer and thus the color layer appears to be colored. Therefore, when the curing liquid is ejected from the nozzle 54 of the ejection head 52 and the test pattern is formed on the top surface 45A of the display substrate 45, the test pattern is visible with the color of the color layer. When the curing liquid attached to the blocking layer is removed by, for example, being dried, light is reflected again and the color layer, again, does not appear to be colored. The curing liquid is attached to, and removed from (by, for example, being dried), the display substrate 45 in repetition in this manner, so that the display substrate 45 is usable repeatedly. A transparent layer, instead of the color layer, may be located below the blocking layer. Even with the transparent layer, a portion to which the curing liquid is attached, and a portion to which the curing liquid is not attached, are distinguishable from each other.

As shown in FIG. 1, the printing tank unit 30 includes a heater/cooler 42, which heats/cools the display substrate 45. The heater/cooler 42 is located below the inspection stage 40. There is no specific limitation on the location of the heater/cooler 42. The heater/cooler 42 includes, for example, a Peltier device. The Peltier device is an element in which heat is transferred when being supplied with an electric current. Therefore, when an electric current is supplied to the Peltier device, one surface thereof is heated and the other surface thereof is cooled. When the direction of the electric current is reversed, the surface to be heated and the surface to be cooled are reversed. The Peltier device performs heating and cooling with one element, and is compact and simple. The heater/cooler 42 heats the display substrate 45, and as a result, the drying of the curing liquid attached to the top surface 45A of the display substrate 45 is promoted. When the display substrate 45 is heated and thus dried to cause the test pattern on the top surface 45A to disappear, the display substrate 45A is cooled for the next cycle formation of the test pattern. The three-dimensional printing device 10 includes the heater/cooler 42, so that the test pattern can be formed in the next cycle with a relatively short time interval. The heater/cooler 42 does not need to include the Peltier element, and may include a heater and a cooler in a separate manner. Alternatively, the heater/cooler 42 may include only the heater and leaves the display substrate 45A cooled by natural release of the heat.

As shown in FIG. 1, the feeding direction transporter 12 moves the printing tank unit 30 in the feeding direction X with respect to a head unit 50, the powder supply 20, the spreading roller 18 and the like. In this preferred embodiment, the feeding direction transporter 12 includes a pair of guide rails 13 and a feed motor 14.

As shown in FIG. 1, the guide rails 13 guide the movement of the printing tank unit 30 in the feeding direction X. The guide rails 13 are provided in the main body 11. The guide rails 13 extend in the feeding direction X. The printing tank unit 30 is slidably engaged with the guide rails 13. There is no specific limitation on the position or the number of the guide rails 13. The feed motor 14 is connected with the printing tank unit 30 via, for example, a ball screw or the like. The feed motor 14 is electrically connected with the controller 100. The feed motor 14 is driven to rotate, and as a result, the printing tank unit 30 is moved on the guide rails 13 in the feeding direction X.

As shown in FIG. 1, the powder supply 20 supplies the powder material 90 into the printing tank 32 of the printing tank unit 30. The powder supply 20 is located above the printing tank unit 30. The powder supply 20 is located to the front of the ejection head 52. The powder supply 20 includes a storage tank 22 and a supply mechanism 24.

The storage tank 22 stores the powder material 90. The storage tank 22 is located above the printing tank unit 30. On a top surface 11A of the main body 11, a support 26 extending upward is provided. The storage tank 22 is supported by the support 26. The storage tank 22 is opened upward. The length of the storage tank 22 in the front-rear direction X is longest at a top portion thereof and is decreased toward a bottom portion thereof.

As shown in FIG. 1, a bottom surface of the storage tank 22 is provided with a supply opening 23. The powder material 90 in the storage tank 22 is supplied onto the printing table 34 in the printing tank 32 via the supply opening 23. The supply opening 23 is rectangular in FIG. 1, but there is no specific limitation on the shape of the supply opening 23.

As shown in FIG. 1, the supply mechanism 24 supplies the powder material 90 in the storage tank 22 into the printing space 32A of the printing tank 32. There is no specific limitation on the structure of the supply mechanism 24. The supply mechanism 24 is, for example, a rotary valve. The supply mechanism 24 is located in the storage tank 22. The supply mechanism 24 is located in the storage tank 22 as being buried in the power material 90. The supply mechanism 24 is connected with a supply motor 25. The supply motor 25 is electrically connected with the controller 100. The supply motor 25 is driven to rotate the supply mechanism 24. The supply mechanism 24 is rotated in the state where the printing tank 32 is located below the supply opening 23 of the storage tank 22, and as a result, a portion of the powder material 90 is supplied into the printing space 32A of the printing tank 32 via the supply opening 23.

As shown in FIG. 1, the spreading roller 18 spreads the powder material 90, supplied by the powder supply 20 to fill the printing space 32A. The spreading roller 18 flattens a surface of the powder material 90 supplied onto the printing table 34 to form a homogeneous powder layer. The spreading roller 18 is located above the main body 11. The spreading roller 18 is located between the supply opening 23 of the storage tank 22 and the ejection head 52 in the feeding direction X. The spreading roller 18 is located to the rear of the supply opening 23. The spreading roller 18 is located to the front of the ejection head 52. The spreading roller 18 has an elongated cylindrical shape. The spreading roller 18 is located such that the axis of the cylindrical shape extends along the scanning direction Y. The length of the spreading roller 18 in the scanning direction Y is longer than the length of the printing space 32A of the printing tank 32 in the scanning direction Y. A bottom end of the spreading roller 18 is slightly above the printing tank unit 30 such that a predetermined clearance is provided between the spreading roller 18 and the top surface 31 of the printing tank unit 30. The spreading roller 18 is rotatably supported by a pair of supports 58 provided on the top surface 11A of the main body 11.

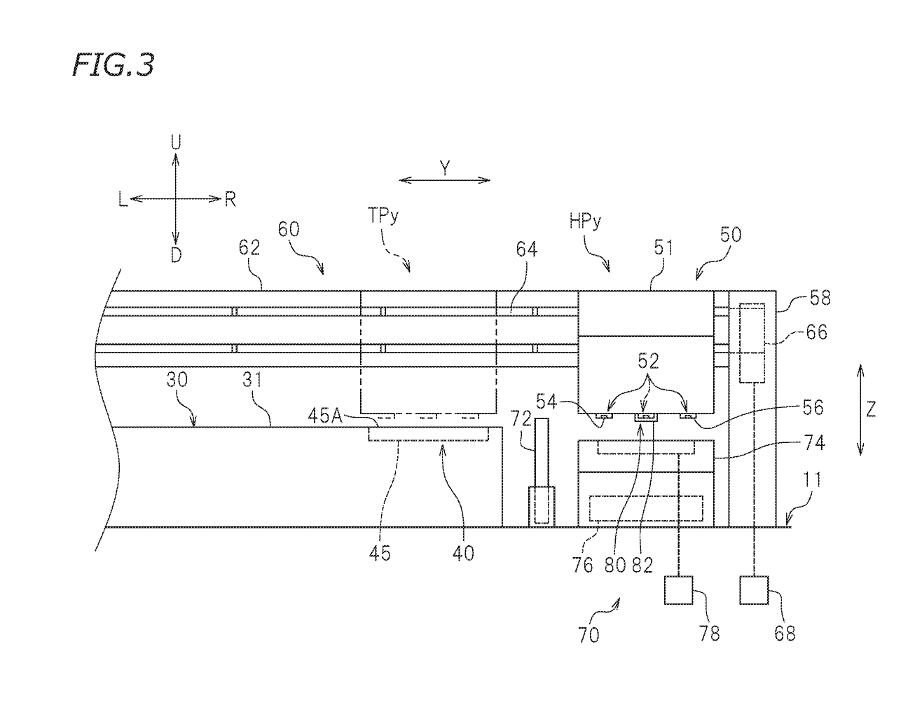

As shown in FIG. 2, the head unit 50 includes a carriage 51, a plurality of the ejection heads 52 mounted on the carriage 51, and a detector 80 also mounted on the carriage 51. FIG. 3 is a front view schematically showing the head unit 50 and the vicinity thereof. FIG. 3 does not show the spreading roller 18. As shown in FIG. 3, the plurality of ejection heads 52 and the detector 80 are located on a bottom surface of the carriage 51. The ejection heads 52 are members that eject the curing liquid, which bonds the particles of the powder material 90 to each other, toward the powder material 90 placed on the printing table 34. The plurality of ejection heads 52 are arrayed in the scanning direction Y. The ejection heads 52 each include a plurality of nozzles 54, from which the curing liquid is to be ejected, and also each include a nozzle surface 56, in which the plurality of nozzles 54 are provided. As shown in FIG. 2, the plurality of nozzles 54 are arrayed in a straight line in the feeding direction X. The nozzle surfaces 56 are located above the top surface 31 of the printing tank unit 30 and are directed downward. There is no specific limitation on the mechanism by which the ejection heads 52 eject the curing liquid. The ejection heads 52 may be, for example, of an inkjet system. The ejection heads 52 are electrically connected with the controller 100. The ejection of the curing liquid from the nozzles 54 of the ejection heads 52 is controlled by the controller 100.

The detector 80 is a device that captures an image of the test pattern formed on the top surface 45A of the display substrate 45 as image data. The detector 80 includes a camera 82 directed downward. The detector 80 is provided to the front of the ejection heads 52 in the carriage 51. The detector 80 is structured such that when the inspection stage 40 is moved to a position below the head unit 50, the image data on the test pattern is acquired by the camera 82. The detector 80 captures the image of the test pattern as the image data to detect a position, on the top surface 45A of the display substrate 45, at which the curing liquid has landed. The detector 80 is electrically connected with the controller 100. The acquirement of the image data by the detector 80 is controlled by the controller 100.

The scanning direction transporter 60 moves the carriage 51 in the scanning direction Y. As shown in FIG. 3, the scanning direction transporter 60 includes a guide rail 62. The guide rail extends in the scanning direction Y. The carriage 51 is slidably engaged with the guide rail 62. An endless belt 64 is secured to the carriage 51. The endless belt 64 is wound around, and extends between, two pulleys 66 provided to the right, and to the left, of the guide rail 62 (only the right pulley 66 is shown). A carriage motor 68 is attached to the right pulley 66. The carriage motor 68 is electrically connected with the controller 100. The carriage motor 68 is controlled by the controller 100. When the carriage motor 68 is driven, the pulley 66 is rotated, and thus the belt 64 runs. As a result, the carriage 51 is moved along the guide rail 62 in the scanning direction Y. Along with the movement of the carriage 51 in the scanning direction Y, the plurality of ejection heads 52 are also moved in the scanning direction Y. The scanning direction transporter 60 and the feeding direction transporter 12 are included in a transporter of the three-dimensional printing device 10.

The feeding direction transporter 12 and the scanning direction transporter 60 move the printing tank unit 30 and the head unit 50 to any of a plurality of positions when necessary. FIG. 1 through FIG. 3 each show a state where the printing tank unit 30 and the head unit 50 are each located at a home position. The “home position” is a position where each of the printing tank unit 30 and the head unit 50 are in a wait state while the printing is not performed. As shown in FIG. 1, a home position HPx of the printing tank unit 30 is a foremost position in the main body 11. As shown in FIG. 3, a home position HPy of the head unit 50 is a right end of the guide rail 62.

The cleaner 70 performs maintenance on, and cleans, the nozzles 54 of the ejection heads 52. As shown in FIG. 3, the cleaner 70 is located below the head unit 50 at the home position HPy. The cleaner 70 includes a wiper 72, a cap 74, a cap transporter 76, and a suction pump 78.

The wiper 72 wipes the nozzle surfaces 56 of the ejection heads 52. The wiper 72 is structured to contact the nozzle surfaces 56 when the ejection heads 52 pass above the wiper 72. The wiper 72 is a plate-shaped member and is made of, for example, rubber or the like. The wiper 72 is provided in a running range of the head unit 50. Namely, the wiper 72 is located to the left of the home position HPy of the head unit 50. The nozzle surfaces 56 are wiped by the wiper 72 at least when being transferred from the wait state to a printing state and when being returned from the printing state to the wait state. In addition, the ejection heads 52 are wiped by the wiper 72 when a wiping instruction is issued from the controller 100.

The cap 74 prevents the nozzles 54 from being clogged as a result of the curing liquid attached to the nozzle surfaces 56 of the ejection heads 52 being cured. The cap 74 is attached from below the ejection heads 52 located at the home position HPy so as to cover the nozzle surfaces 56. The cap 74 is made of, for example, rubber or the like. The cap 74 is movable in the up-down direction Z by the cap transporter 76. In the state where the cap 74 is attached to the ejection heads 52, a closed space is provided between the cap 74 and the nozzle surfaces 56. The cap transporter 76 moves the cap 74 downward before the printing is started, so as to separate the cap 74 from the nozzle surfaces 56. As a result, the cap 74 is detached from the ejection heads 52.

The cleaner 70 includes the suction pump 78 absorbing the curing liquid in the closed space in the state where the cap 74 is attached to the ejection heads 52. The absorption by the suction pump 78 causes an inner pressure of the closed space to be lower than the atmospheric pressure. As a result, the suction pump 78 absorbs the curing liquid in the nozzles 54 of the ejection heads 52. The curing liquid in the closed space absorbed by the suction pump 78 is stored in a waste liquid tank (not shown). The absorption is a cleaning work performed to solve the defective ejection of the nozzles 54, and also is a maintenance work performed to prevent the nozzles 54 of the ejection heads 52 from being clogged.

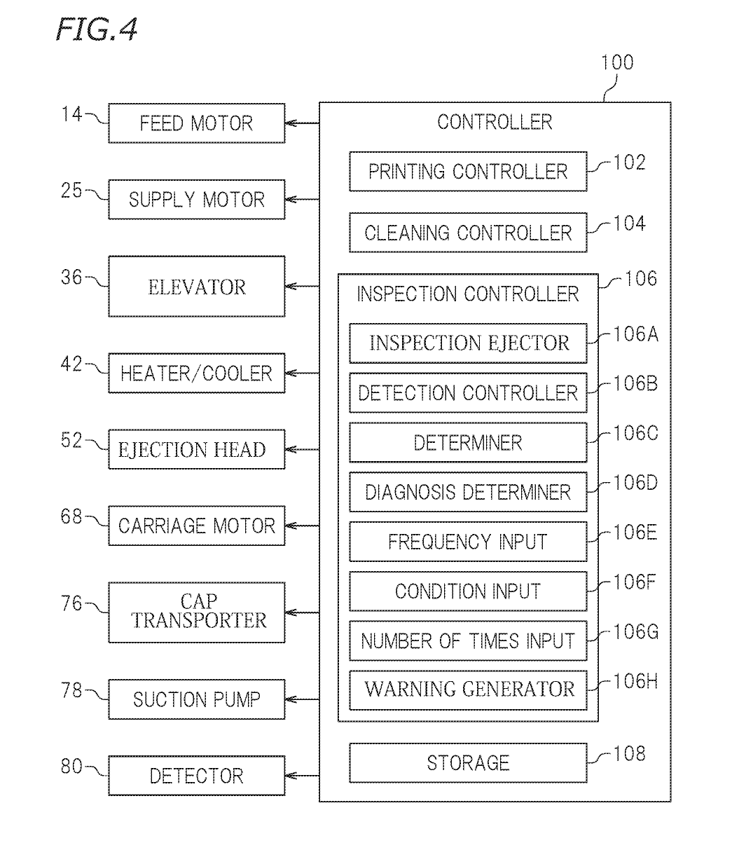

As shown in FIG. 1, an operation panel 110 is provided on a front surface of the main body 11. The operation panel 110 includes a display that displays the state of the three-dimensional printing device 10, input keys operable by a user, and the like. The operation panel 110 is connected with the controller 100 controlling various operations of the three-dimensional printing device 10. FIG. 4 is a block diagram of the three-dimensional printing device 10 in this preferred embodiment. As shown in FIG. 4, the controller 100 is communicably connected with, and is configured or programmed to control, the feed motor 14, the supply motor 25, the elevator 36, the heater/cooler 42, the ejection heads 52, the carriage motor 68, the cap transporter 76, the suction pump 78, and the detector 80. The controller 100 includes a printing controller 102, a cleaning controller 104, an inspection controller 106, and a storage 108.

There is no specific limitation on the structure of the controller 100. The controller 100 is, for example, a microcomputer. There is no specific limitation on the hardware structure of the microcomputer. The controller 100 includes, for example, an interface (I/F) receiving printing data and the like from an external device such as a host computer or the like, a central processing unit (CPU) executing instructions of a control program or programs, a ROM (read only memory) including stored thereon a program or programs executable by the CPU, a RAM (random access memory) usable as a working area in which the program(s) is developed, and a storage such as a memory or the like storing the above-described program and various types of data. The controller 100 does not need to be provided in the three-dimensional printing device 10, and may be, for example, a computer that is installed outside the three-dimensional printing device 10 and is communicably connected with the three-dimensional printing device 10 in a wired or wireless manner.

The printing controller 102 controls various elements of the three-dimensional printing device 10 such that a three-dimensional object 92 is printed. The printing controller 102 controls the supply motor 25 such that the powder material 90 is provided into the printing tank 32. Then, the printing controller 102 controls the feed motor 14, the carriage motor 68 and the ejection heads 52 such that one cured layer 91 is formed. The printing controller 102 repeats an operation of printing one cured layer 91 as described above while controlling the elevator 36 such that the printing table 34 is lowered each time one such layer is to be formed. As a result, the three-dimensional object 92 is printed. The printing process will be described in detail below.

The cleaning controller 104 controls various elements of the three-dimensional printing device 10 such that the ejection heads 52 are cleaned. When any of the ejection heads 52 is recognized to be abnormal, the cleaning controller 104 cleans the ejection heads 52 based on an instruction from the inspection controller 106. The details of the cleaning will be described below.

The inspection controller 106 controls various elements of the three-dimensional printing device 10 such that the ejection heads 52 are inspected, and such that a recovery process is performed if an abnormality is detected. The above-described cleaning of the ejection heads 52 is a part of the recovery process. The inspection controller 106 includes an inspection ejector 106A, a detection controller 106B, a determiner 106C, a diagnosis determiner 106D, a frequency input 106E, a condition input 106F, a number of times input 106G, and a warning generator 106H.

The inspection ejector 106A causes the test pattern to be formed on the top surface 45A of the display substrate 45. The inspection ejector 106A causes the curing liquid to be ejected toward the top surface 45A of the display substrate 45 from the ejection heads 52, so as to form the test pattern. The inspection ejector 106A controls the feeding direction transporter 12 and the scanning direction transporter 60 such that the inspection stage 40 is moved to a position below the head unit 50, and then controls the ejection heads 52 such that the test pattern is formed. The test pattern is formed at least before and after one three-dimensional object 92 is printed. Even during the printing of one three-dimensional object 92, if a frequency is input to the frequency input 106E, the inspection ejector 106A causes the test pattern to be formed at such a frequency. In addition, after the diagnosis determiner 106D diagnoses an ejection head 52 abnormal and this ejection head 52 is cleaned (described below), the inspection ejector 106A causes the test pattern to be formed. The test pattern is formed each time any of the ejection heads 52 is diagnosed as abnormal and then is cleaned.

The detection controller 106B controls the detector 80 such that the image data on the test pattern is acquired. The detector 80 in this preferred embodiment is located close to a front end of the carriage 51. While the printing tank unit 30 is being returned forward after the formation of the test pattern, the detector 80 acquires images of the test pattern along the feeding direction X.

The determiner 106C determines whether or not each of the nozzles 54 has an ejection abnormality based on the acquired images of the test pattern. The determiner 106C determines whether or not there is any nozzle 54 from which the curing liquid is not ejected, or whether or not there is any other type of abnormality, based on the position of dots of the curing liquid on the top surface 45A of the display substrate 45.

The diagnosis determiner 106D diagnoses each of the ejection heads 52 as being normal or abnormal based on the position(s) or the like of the nozzle(s) 54 determined to be abnormal by the determiner 106C. When any ejection head 52 is diagnosed as being abnormal, the diagnosis determiner 106D instructs the cleaning controller 104 to clean the ejection heads 52. The condition under which any ejection head 52 is diagnosed as abnormal (hereinafter, referred to as an “abnormality condition”) is input to the condition input 106F. When the position(s) or the like of the abnormal nozzle(s) 54 fulfills the abnormality condition input to the condition input 106F, the diagnosis determiner 106D diagnoses the corresponding ejection head 52 as abnormal.

As described above, the three-dimensional printing device 10 in this preferred embodiment re-inspects the ejection heads 52 after the ejection heads 52 are cleaned. The three-dimensional printing device 10 is set such that in the case where the ejection head 52 is abnormal even in the re-inspection, the ejection head 52 is re-cleaned. The three-dimensional printing device 10 in this preferred embodiment repeats such a cleaning and inspection operation until the ejection head 52 is returned to a normal state or the number of times of cleaning reaches the upper limit (described below) input to the number of times input 106G.

The frequency input 106E is a portion to which a frequency of inspection performed on the ejection heads 52 is to be input. The frequency input 106E causes an input screen to be displayed on, for example, the operation panel 110, a display device of an external computer, or the like. To the frequency input 106E, a frequency of inspection to be performed during the printing of one three-dimensional object 92 is input. There is no limitation on the parameter of the frequency that is to be input to the frequency input 106E. In this preferred embodiment, the “number of the cured layers” is input. In the case where, for example, “100” is input to the frequency input 106E as the number of the cured layers, the ejection heads 52 are inspected each time 100 cured layers 91 are stacked. Even if no input is made to the frequency input 106E, the inspection is performed at least before and after one three-dimensional object 92 is printed. The three-dimensional printing device 10 in this preferred embodiment is set to inspect the ejection heads 52 at least before and after one three-dimensional object 92 is printed.

The condition input 106F is a portion to which a condition under which each of the ejection heads 52 is diagnosed as abnormal is to be input. The condition input 106F also causes an input screen to be displayed on, for example, the operation panel 110, a display device of an external computer, or the like. There is no limitation on the parameter of the abnormality condition that is to be input to the condition input 106F. In this preferred embodiment, the “number of abnormal nozzles” and “distance between abnormal nozzles” are input. It is now assumed that, for example, “10” is input to the condition input 106F as the number of abnormal nozzles. In the case where at least ten of all the nozzles 54 of each ejection head 52 are determined to be abnormal, the corresponding ejection head 52 is diagnosed as abnormal. It is assumed that “50 pitches” is input to the condition input 106F as the distance between abnormal nozzles. In the case where the shortest distance among the distances between two abnormal nozzles 54 is 50 pitches or shorter, the corresponding ejection head 52 is diagnosed as abnormal. Herein, “1 pitch” is the distance between adjacent dots of the curing liquid in the test pattern.

The number of times input 106G is a portion to which the upper limit of the number of times of cleaning is to be input. The number of times input 106G also causes an input screen to be displayed on, for example, the operation panel 110, a display device of an external computer, or the like. In this preferred embodiment, when the number of times of the cleaning and inspection operation performed in repetition reaches the upper limit that is input to the number of times input 106G, the operation is stopped. The warning generator 106H issues a warning at this point. The warning generator 106H causes a warning screen to be displayed on, for example, the operation panel 110, a display device of an external computer, or the like.

The storage 108 stores the inspection results on each of the nozzles 54. In this preferred embodiment, the storage 108 records the inspection results on each nozzle 54 together with the situation in which the inspection was performed. For example, the storage 108 records the inspection results on each nozzle 54 together with situation data such as, for example, the date of printing, how many times the printing was performed before the printing of interest, how many times the inspection was performed in the printing of interest before the inspection of interest was performed, or in the case where the inspection was performed after the cleaning, how many times the cleaning was performed before the cleaning of interest. This record is stored as data as a part of the printing history of the printed three-dimensional object 92, or as data showing the tendency of abnormality of the nozzles 54.

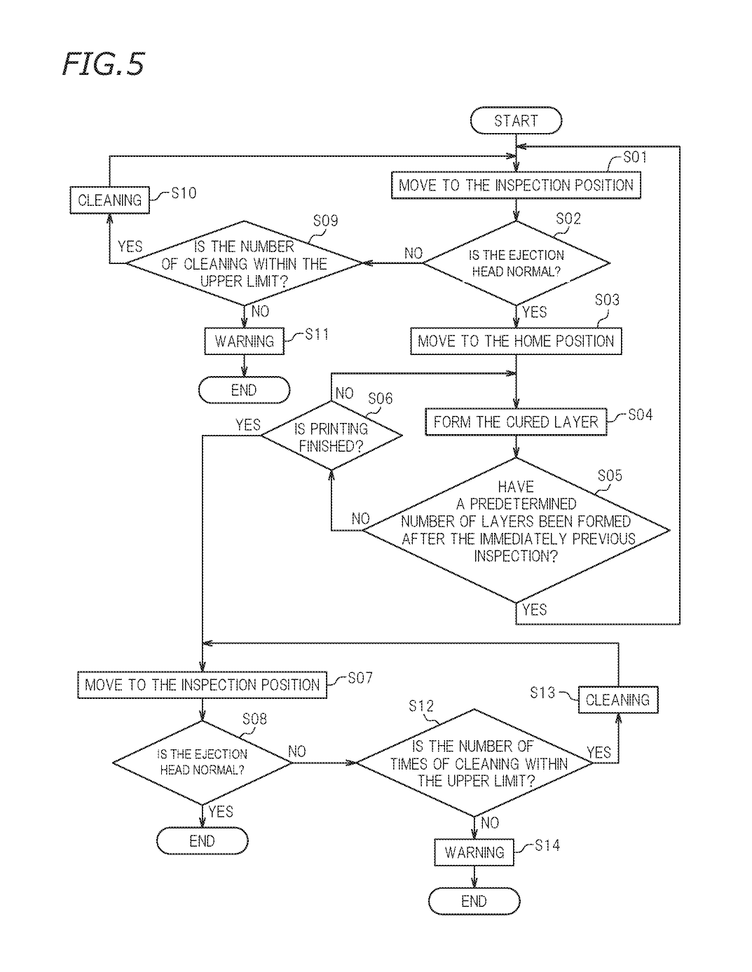

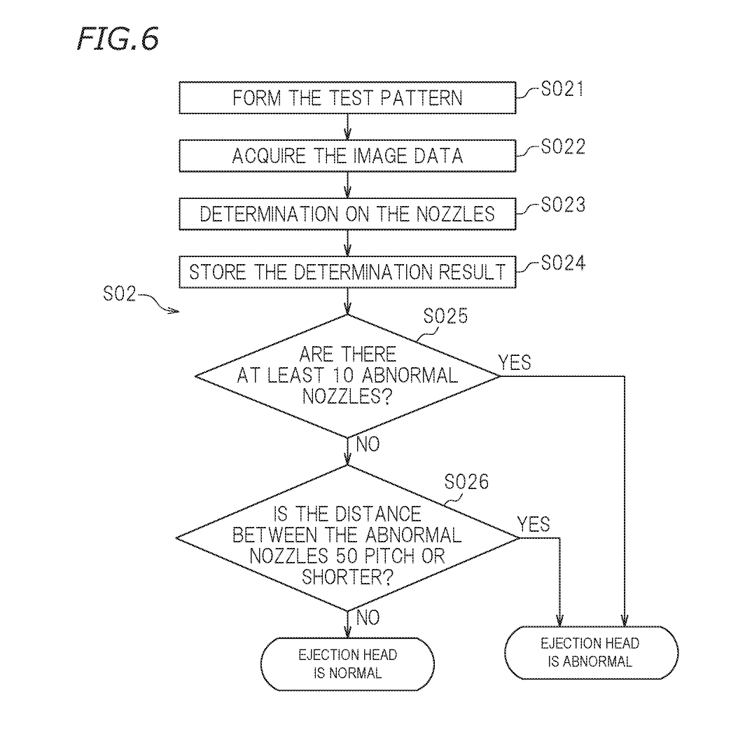

The three-dimensional printing device 10 in this preferred embodiment prints the three-dimensional object 92 by performing the process described below. FIG. 5 is a flowchart showing an example of printing process performed by the three-dimensional printing device 10 in this preferred embodiment. FIG. 6 is a flowchart showing steps in step S02 shown in FIG. 5. In the following description, it is assumed that the number of the cured layers 91 is 250 and that the frequency of inspection input to the frequency input 106E is “100 layers”. It is also assumed that the abnormality conditions input to the condition input 106F are that the “number of abnormal nozzles is at least ten”, that the “distance between abnormal nozzles is 50 pitches or shorter”, and that the upper limit of the number of times of cleaning input to the number of times input 106G is three. The above-described conditions are merely examples, and the printing may be carried out under various other conditions.

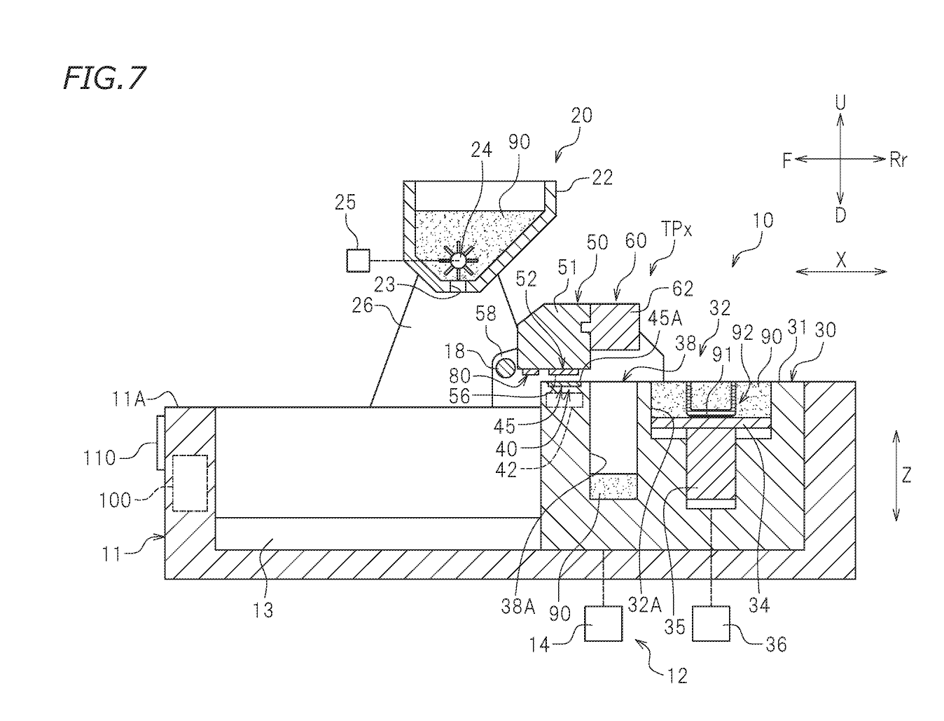

The flowchart shown in FIG. 5 starts with step S01. In step S01, the printing tank unit 30 and the head unit 50 are moved such that the three-dimensional printing device 10 assumes an “inspection position”. The inspection position is a position at which the ejection heads 52 are inspected. At the inspection position, the head unit 50 is just above the inspection stage 40. FIG. 7 is a schematic cross-sectional view of the three-dimensional printing device 10 showing a state where the printing tank unit 30 is in an inspection state. In FIG. 3, the head unit 50 at the inspection position is represented by the two-dot chain line. As shown in FIG. 7, an inspection position TPx of the printing tank unit 30 is a rearmost position in the main body 11. In step S01, the feeding direction transporter 12 drives the feed motor 14 to move the printing tank unit 30 to the inspection position TPx. As shown in FIG. 3, an inspection position TPy of the head unit 50 is at the same position as that of the inspection stage 40 in the scanning direction Y. The scanning direction transporter 60 drives the carriage motor 68 to move the head unit 50 to the inspection position TPy.

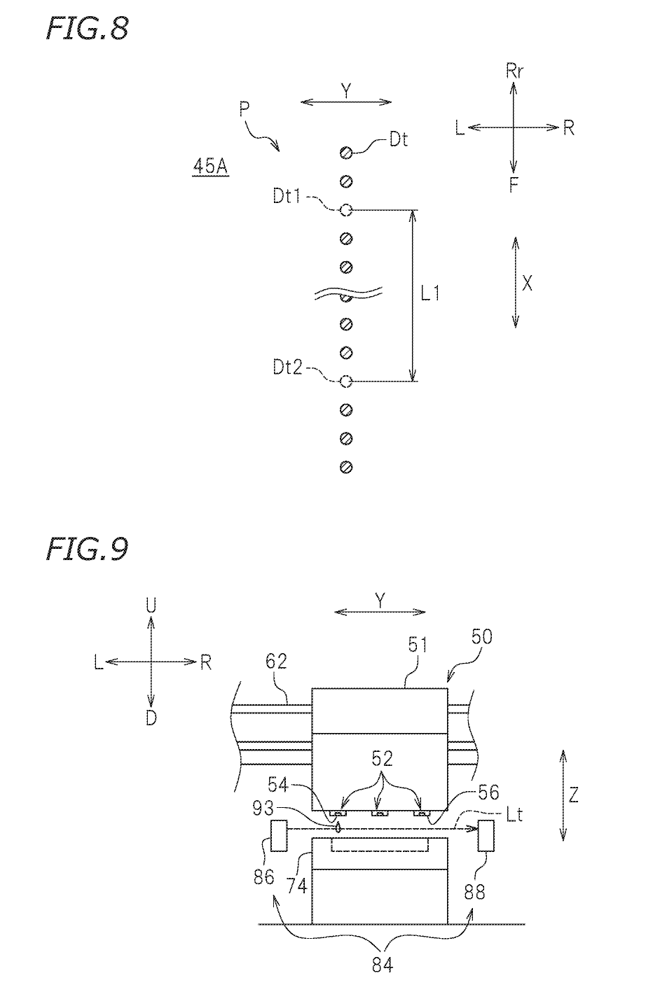

Next, in step S02, the three-dimensional printing device 10 inspects the ejection heads 52. As shown in FIG. 6, step S02 includes step S021, step S022, step S023, step S024, step S025 and step S026. In step S021, the test pattern is formed on the top surface 45A of the display substrate 45. FIG. 8 is a schematic view showing an example of test pattern P. The test pattern shown in FIG. 8 is of a case where neither the printing tank unit 30 nor the head unit 50 is moved during the formation of the test pattern P. In the test pattern P shown in FIG. 8, dots Dt of the curing liquid land at the same positions as those of the nozzles 54 on the nozzle surface 56. Namely, in the test pattern P, the dots Dt of the curing liquid are arrayed in the feeding direction X at the same pitch as that of the nozzles 54 on the nozzle surface 56. This is merely an example. Alternatively, for example, the printing tank unit 30 may be moved during the formation of the test pattern P to increase the interval between the dots Dt of the curing liquid, so as to allow individual dots Dt to be more easily distinguished from each other. As described above, the top surface 45A of the display substrate 45 is of the blocking layer, and while the curing liquid is attached thereto, transmits light. The blocking layer transmits light, and as a result, the color layer appears to be colored and thus the positions of the dots Dt of the curing liquid are recognized.

In step S022, image data on the test pattern P formed in step S021 is acquired. In step S022, the detection controller 106B causes the camera 82 of the detector 80 to take an image of the test pattern P. The detector 80 in this preferred embodiment is located close to the front end of the carriage 51. The detection controller 106B returns the printing tank unit 30 forward while acquiring images of the test pattern P sequentially in the feeding direction X. Alternatively, the camera 82 may have a field of view so as to take an image of the entirety of the test pattern P at once, and the image data on the test pattern P may be acquired with no movement of the printing tank unit 30. There is no limitation on the specifications of the camera 82.

In step S023, each of the nozzles 54 is determined to be normal or abnormal based on the image data on the test pattern P acquired in step S022. This determination is made by the determiner 106C. FIG. 8 shows a state where two dots Dt1 and Dt2, among the dots Dt of the curing liquid, are missing. This indicates that the nozzles 54 of the ejection head 52 corresponding to the dots Dt1 and Dt2 do not eject the curing liquid. In the case shown in FIG. 8, the determiner 106C determines that two nozzles 54 corresponding to the two dots Dt1 and Dt2 are abnormal based on the image data on the test pattern P.

In step S024, the results of the determination on each of the nozzles 54 made in step S023 are stored on the storage 108. Together with the determination results, situation data indicating that the determination results are of an inspection performed before the printing is stored on the storage 108. When the inspection is performed during or after the printing, such situation data is stored together with the determination results.

In step S025 and S026, it is diagnosed, based on the determination results on each of the nozzles 54 acquired in step S023, whether the corresponding ejection head 52 is normal or abnormal. The abnormality conditions based on which the ejection head 52 is diagnosed as abnormal are already input to the condition input 106F. Herein, there are two abnormality conditions. One of the abnormality conditions is that the “number of abnormal nozzles is at least ten”. In step S025, the determination is made based on this abnormality condition. In the case shown in FIG. 8, the number of abnormal nozzles 54 is two. Therefore, in the case shown in FIG. 8, the determination result in step S024 is “NO”. In this case, the printing process advances to step S026. If the number of abnormal nozzles 54 is at least ten, the determination result in step S024 is “YES”, and the ejection head 52 is diagnosed “abnormal” without the process advancing to step S026.

The other abnormality condition is that the “shortest distance among the distances between two abnormal nozzles 54 is 50 pitches or shorter”. In step S026, the determination is made based on this abnormality condition only when the determination result is “NO” in step S025. In the case shown in FIG. 8, the distance between the missing dots Dt1 and Dt2 of the curing liquid is L1. In the case where, for example, the distance L1 is longer than 50 pitches, the determination results in step S026 is “NO”. In this case, the ejection head 52 is diagnosed “normal”. By contrast, in the case where the distance L1 is 50 pitches or shorter, the determination results in step S026 is “YES”. In this case, the ejection head 52 is diagnosed “abnormal”. The normal/abnormal diagnosis in step S025 or 5026 is the diagnosis result in step S02. In the case where the diagnosis result is “normal”, the diagnosis result in step S02 is “YES”, and the printing process advances to step S03. In the case where the diagnosis result is “abnormal”, the diagnosis result in step S02 is “NO”, and the printing process advances to step S09.

It is now assumed that the diagnosis result in step S02 is “normal” and the printing process advances to step S03. In this case, in step S03, the printing tank unit 30 and the head unit 50 are moved to the respective home positions.

After the printing tank unit 30 and the head unit 50 are moved to the respective home positions in step S03, one curing layer 91 is formed in step S04. In step S04, first, the printing tank unit 30 is moved such that the printing tank 32 is below the powder supply 20, and the powder material 90 is supplied from the powder supply 20 into the printing tank 32. Next, the printing controller 102 controls the feed motor 14 such that the printing tank unit 30 is moved rearward and a powder layer is formed in the printing tank 32 by the spreading roller 18. Along with the movement of the printing tank unit 30, the powder material 90 supplied into the printing tank 32 is gradually flattened to have a height equal to the level of the bottom surface of the spreading roller 18 and thus forms a powder layer. Toward the powder layer thus formed, the curing liquid is ejected from the nozzles 54 of the ejection heads 52. At this point, the curing liquid is ejected toward a region corresponding to the cross-sectional shape of the three-dimensional object 92. The printing controller 102 drives the carriage motor 68 to move the carriage 51 in the scanning direction Y while causing the curing liquid to be ejected toward a desired position on the powder layer.

After step S04, in step S05, the controller 100 determines whether or not the number of the cured layers 91 formed after the immediately previous inspection on the ejection heads 52 has reached the number of layers input to the frequency input 106E. Herein, “100” is input to the frequency input 106E. Until the number of the cured layers 91 reaches 100, the formation of the cured layer 91 is repeated (the determination result in step S05 is “NO” and the printing process is returned to before step S04). In the case where it is selected to form a new cured layer 91 in this manner, the printing controller 102 drives the elevator 36 to lower the printing table 34 by a height corresponding to one cured layer (e.g., by about 0.1 mm). Then, the powder material 90 is supplied from the powder supply 20 into the printing tank 32, and step S04 is repeated.

When the formation of the cured layer 91 is repeated 100 times and the determination result in step S05 is “YES”, the printing process is returned to before step S01. Namely, the printing tank unit 30 and the head unit 50 are again moved to the respective inspection positions, and then in step S02, the ejection heads 52 are inspected again. In the case where the ejection heads 52 are diagnosed “normal” in this inspection also, the printing process advances to step S03. In step S03 in the second cycle, the printing is continued until the number of the cured layers 91 reaches 200. When the number of the cured layers 91 reaches 200, the printing process is returned to before step 01 again.

The printing proceeds while the ejection heads 52 are inspected twice in this manner. When the formation of the 250th cured layer 91 is finished, the printing is finished. Namely, the three-dimensional object 92 is completed. At this point, “YES” is selected in step S06. When “YES” is selected in step S06, the printing process advances to step S07. In step S07, the printing tank unit 30 and the head unit 50 are moved to the respective inspection positions in order to have the ejection heads 52 inspected after the printing. After step S07, the printing process advances to step S08, where the inspection heads 52 are inspected after the printing. The inspection in step S08 is the same as that in step S02. In the case where the ejection heads 52 are diagnosed “normal” and “YES” is selected in step S08, the printing process is finished.

The above-described printing process is of a case where no abnormality is recognized of the ejection heads 52 in step S02. In the case where any abnormality of any of the ejection heads 52 is recognized in step S02, the printing process advances to step S09 and then to step S10 from step S02. In step S09, in the case where the cleaning has been performed a plurality of times, it is determined whether or not the number of times of cleaning has reached the upper limit. In the case where the determination result in step S09 is “YES”, (in the case where the number of times of cleaning has not reached the upper limit), the printing process advances to step S10. In step S10, the ejection heads 52 are cleaned. In step S10, the head unit 50 is moved to the home position HPy. During the movement, the nozzle surfaces 56 of the ejection heads 52 are wiped by the wiper 72. At the home position HPy, the cap 74 is attached to the ejection heads 52 and the suction pump 78 performs the absorption. In the case where any of the ejection heads 52 is diagnosed as abnormal, the ejection heads 52 are cleaned in this manner.

After the cleaning in step S10, the inspection controller 106 re-inspects the ejection heads 52. In the case where the ejection heads 52 are diagnosed as normal in the re-inspection, the printing process advances to step S03 and the printing is started or re-started. In the case where any of the ejection heads 52 is diagnosed as abnormal again, the printing process advances to step S09 and then step S10, where the cleaning is performed again. The cleaning in step S10 is performed repeatedly until the ejection heads 52 are diagnosed as normal, or until it is determined that the number of times of cleaning has reached the upper limit in step S09. The upper limit of the number of times of cleaning is input to the number of times input 106G. Herein, the upper limit of the number of times of cleaning is three, for example. In the case where any of the ejection heads 52 is still diagnosed as abnormal after being cleaned three times, “NO” is selected in step S09 and the printing process advances to step S11. In step S11, the warning generator 106H issues a warning to the user. This warning indicates that the cleaning provides no effect and that the printing cannot be started or re-started.

In the case where any of the ejection heads 52 is recognized as being abnormal in step S08 (inspection of the ejection heads 52 after the printing is finished), the ejection heads 52 are cleaned in step S12 and step S13 in substantially the same manner as in step S09 and step S10. Since the printing has already been finished, the ejection heads 52 are merely cleaned. In the case where such an abnormal ejection head 52 is not returned to the normal state even after being cleaned the upper limit number of times, the warning generator 106H issues a warning in step S14.

Although omitted in the flowcharts in FIG. 5 and FIG. 6, after the ejection heads 52 are inspected, the display substrate 45 is heated and cooled by the heater/cooler 42. The heater/cooler 42 heats and thus dries the display substrate 45 to erase the test pattern from the display substrate 45. After this, the heater/cooler 42 cools the display substrate 45 such that the test pattern may be displayed again. The heater/cooler 42 heats and cools the display substrate 45 after each inspection in step S02 or step S08.

The printing process performed by the three-dimensional printing device 10 is described above. As described above, the three-dimensional printing device 10 in this preferred embodiment automatically diagnoses whether the ejection heads 52 are normal or abnormal at least before and after the printing. Therefore, the printed object is guaranteed to have a high level of quality, especially, a high level of strength. In addition, the three-dimensional printing device 10 in this preferred embodiment includes the frequency input 106E, so that the ejection heads 52 is able to be inspected even during the printing. Therefore, the printed object is guaranteed to have a higher level of quality.

The three-dimensional printing device 10 in this preferred embodiment includes the condition input 106F, so that an abnormality condition is able to be input to set a permissible level of defect of the ejection heads 52. The three-dimensional printing device 10 in this preferred embodiment is able to provide both of a high level of quality of each printed object and a high level of productivity of printed objects as long as the abnormality condition is set appropriately. Preferable examples of parameters of the abnormality condition include the number of abnormal nozzles 54, the distance between abnormal nozzles 54, and the like.

The three-dimensional printing device 10 in this preferred embodiment includes the cleaner 70, so that the ejection heads 52 are be diagnosed as normal or abnormal and also an abnormal ejection head 52 is able to be returned to a normal state. In principle, the diagnosis determiner 106D in this preferred embodiment causes the cleaning to be performed until the ejection head(s) 52 is(are) returned to a normal state. Therefore, the three-dimensional object 92 is guaranteed to have a high level of quality. The three-dimensional printing device 10 in this preferred embodiment includes the number of times input 106G, so that in the case where no cleaning effect is recognized, the cleaning is stopped. In this manner, it is prevented that time is wasted by performing cleaning against an abnormality that cannot be solved by the cleaning. The three-dimensional printing device in this preferred embodiment includes the warning generator 106H, so that in the case where the number of times of cleaning has reached the upper limit, a warning is issued. This warning allows the user to learn that there is an ejection head 52 including a defect that cannot be solved by the cleaning.

In this preferred embodiment, the test pattern is actually formed to check the state of the nozzles 54. The method of using the test pattern to learn the positions at which the curing liquid has landed is foolproof and simple as a method for inspecting the nozzles 54. In the case where the display substrate 45 is used as a medium on which the test pattern is to be formed, the positions at which the curing liquid has landed are able to be determined without fail. The curing liquid is usually transparent and thus is not easily recognized when landing on, for example, paper. In the case where the display substrate 45 is used, the color of positions of the display substrate 45 at which the curing liquid has landed is changed. Therefore, the positions at which the curing liquid has landed are easily recognizable. In addition, unlike paper or the like, the display substrate 45 is usable in repetition. The positions on the display substrate 45 at which the curing liquid has landed may be checked by any of various technologies. The method of using the detector including the camera to recognize the image as in this preferred embodiment is simple and is highly efficient because an image of a certain range of field of view is acquired at once.

The three-dimensional printing device 10 in this preferred embodiment includes the heater/cooler 42, so that the ejection heads 52 are able to be inspected at a relatively short time interval. The heater/cooler 42 may include a heater and a cooler in a separate manner. The heater/cooler 42 including a Peltier element capable of heating and also cooling as in this preferred embodiment is compact and preferred.

In the three-dimensional printing device 10 in this preferred embodiment, the inspection data on the nozzles 54 is stored on the storage 108. This can certify that there is no abnormality in the ejection of the curing liquid during the printing. In addition, since the inspection data is stored in association with the situation of the inspection, the inspection data is useful as data indicating the tendency of ejection abnormality of the nozzles 54.

Preferred embodiments of the present invention are described above. The above-described preferred embodiments are merely examples, and the present invention may be carried out in any of various other forms.

For example, in the above-described preferred embodiments, even if an ejection head 52 is recognized as being abnormal during or after the printing, no warning is issued and the printing is continued unless any problem is detected in the re-inspection after the cleaning. This is based on an idea that even if an ejection head 52 has an ejection abnormality at a time point between inspections, as long as the inspection frequency is set appropriately, the printing is guaranteed to have a high level of quality as a whole. Alternatively, in another preferred embodiment, in the case where an ejection head 52 is diagnosed as abnormal by an inspection during or after the printing, a warning may be issued to stop the printing. This preferred embodiment guarantees a higher level of printing quality. In still another preferred embodiment, the condition input 106F may allow a plurality of abnormality conditions to be input thereto. In this case, a condition under which the ejection heads 52 need to be cleaned but the printing does not need to be stopped is set as a first abnormality condition. A condition under which the printing needs to be stopped is set as a second abnormality condition. In this preferred embodiment, two abnormality conditions may be set appropriately, so that a high level of printing quality and a high level of productivity can be both provided.

In the above-described preferred embodiments, the determination on whether the nozzles 54 are normal or abnormal is made based on the test pattern. The present invention is not limited to this. For example, the determination on whether the nozzles 54 are normal or abnormal is made by catching the curing liquid in the middle of jumping toward a receiver.

FIG. 9 is a schematic view showing an example of mechanism that uses an optical sensor to determine whether the nozzles 54 are normal or abnormal. FIG. 9 is a front view of the head unit 50 and the vicinity thereof. As shown in FIG. 9, the detector 80 in this preferred embodiment includes an optical sensor 84, and the optical sensor 84 includes a light emitter 86 emitting light Lt for inspection and a light receiver 88 receiving the light Lt. The light emitter 86 directs the light Lt toward a region between the nozzle surfaces 56 of the ejection heads 52 and the cap 74 distanced from the ejection heads 52. The light receiver 88 is located to face the light emitter 86, and receives the light Lt directed from the light emitter 86.

Each of the nozzles 54 of each ejection head 52 ejects a curing liquid 93 toward the cap 74. In this preferred embodiment, the cap 74 corresponds to a “receiver”. As shown in FIG. 9, the curing liquid 93 ejected toward the cap 74 from the nozzles 54 crosses the light Lt while jumping. Thus, the curing liquid 93 blocks the light Lt against the light receiver 88 when passing the track of the light Lt. The receipt of the light Lt by the light receiver 88 is temporarily interrupted, and thus the determiner 106C recognizes that the curing liquid 93 has been ejected from the nozzles 54. By contrast, in the case where the receipt of the light Lt by the light receiver 88 is not interrupted, the nozzles 54 are diagnosed as abnormal.

There is no limitation on the specifications of the optical sensor 84. For example, the light emitter 86 of the optical sensor 84 may direct planar light Lt longer than the length of the ejection heads 52 in the feeding direction X, and the light receiver 88 of the optical sensor 84 may receive such light Lt. The optical sensor 84 including such a structure makes a determination on all the nozzles 54 of one ejection head 52 at once. Alternatively, the determination may be made for each nozzle 54 by use of a linear light source.

The method of catching the curing liquid in the middle of jumping to determine whether each of the nozzles 54 is normal or abnormal as described above does not require an inspection site such as the inspection stage 40 to be separately provided, and thus allows the structure of the three-dimensional printing device 10 to be simplified. An optical sensor, when being used to catch the curing liquid in the middle of jumping, is easily attached, allows the wiring to be made easy, and provides a high detection precision. Use of the cap 74 as a receiver does not require any special receiver to be prepared and allows the structure of the three-dimensional printing device 10 to be further simplified.

In the above-described preferred embodiment, the printing tank unit 30 is movable in the feeding direction X with respect to the powder supply 20, the spreading roller 18, the head unit 50 and the like secured to the main body 11. The present invention is not limited to this. For example, the printing tank unit 30 may be secured to the main body 11, whereas the powder supply 20, the spreading roller 18, the head unit 50 may be movable in the feeding direction X with respect to the printing tank unit 30. The three-dimensional printing device 10 may be of a so-called line head system, and, for example, the head unit 50 may be immovable in the scanning direction Y. The printing tank 32, the inspection stage 40, the cleaner 70 and the like are not limited to being located at positions described above, and may be located at any position as long as the three-dimensional printing device 10 functions properly. In the above-described preferred embodiments, the powder supply 20 supplies the powder material 90 to the printing tank 32 from above. The present invention is not limited to this. For example, the powder supply 20 may include a material supply tank provided in the printing tank unit 30 side by side with the printing tank 32, so that the powder material 90 may be supplied from the material supply tank.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing device, comprising:
a printing table on which a powder material is placeable;
an ejection head including a nozzle surface that includes a plurality of nozzles from which a curing liquid curing the powder material is ejected;
a transporter that moves the ejection head, with respect to the printing table, to at least a first position above the printing table and a second position;
a receiver including a receiving surface that faces the nozzle surface in a state where the ejection head is at the second position, the receiver being structured to receive the curing liquid ejected from the plurality of nozzles at the receiving surface;
a detector that detects a position, on the receiving surface, of the curing liquid ejected toward the receiver from the plurality of nozzles; and
a controller configured or programmed to include:
a printing controller that controls the ejection head such that the curing liquid is ejected toward the powder material on the printing table to print a three-dimensional object;
an inspection ejector that controls the ejection head and the transporter such that inspection ejection of ejecting the curing liquid toward the receiver is performed at least before and after the three-dimensional object is printed;
a detection controller that controls the detector such that the position, on the receiving surface, of the curing liquid in the inspection ejection is detected; and
a determiner that determines whether or not each of the plurality of nozzles has an ejection abnormality, based on the position, on the receiving surface, of the curing liquid in the inspection ejection.

2. The three-dimensional printing device according to claim 1, wherein the detector detects a position, on the receiving surface, at which the curing liquid has landed.

3. The three-dimensional printing device according to claim 2, wherein the detector includes a camera to capture an image of the receiving surface.

4. The three-dimensional printing device according to claim 2, wherein
the receiver includes a display substrate including a transparent or color base layer and a blocking layer located on the base layer, the blocking layer including the receiving surface; and
the blocking layer transmits light in a state where the curing liquid is attached thereto and blocks light in a state where the curing liquid is removed therefrom.

5. The three-dimensional printing device according to claim 4, further comprising a heater that heats the receiver.

6. The three-dimensional printing device according to claim 5, further comprising a cooler that cools the receiver.

7. The three-dimensional printing device according to claim 6, wherein the heater and the cooler are integral with each other and include a Peltier element.

8. The three-dimensional printing device according to claim 1, wherein the controller includes a storage that is configured or programmed to store data on determinations made by the determiner.

9. The three-dimensional printing device according to claim 1, wherein the controller is configured or programmed to include a diagnosis determiner that diagnoses the ejection head as abnormal in a case where the nozzle determined to have an ejection abnormality by the determiner fulfills a predetermined condition.

10. The three-dimensional printing device according to claim 9, wherein the diagnosis determiner diagnoses the ejection head as abnormal in a case where a number of the nozzles determined by the determiner to have an ejection abnormality is a predetermined number or larger.

11. The three-dimensional printing device according to claim 9, wherein the diagnosis determiner diagnoses the ejection head as abnormal in a case where the distance between two nozzles among the nozzles determined by the determiner to have an ejection abnormality is a predetermined distance or shorter.

12. The three-dimensional printing device according to claim 9, wherein the controller is configured or programmed to include a condition input to which the predetermined condition is input.

13. The three-dimensional printing device according to claim 9, further comprising a cleaner to clean the ejection head;
wherein the controller is configured or programmed to include a cleaning controller that controls the cleaner such that the ejection head is cleaned in a case where the ejection head is diagnosed as abnormal.

14. The three-dimensional printing device according to claim 13, wherein
the inspection ejector causes the inspection ejection to be performed again after the ejection head is cleaned; and
the cleaning controller causes the ejection head to be cleaned again in the case where the ejection head is diagnosed as abnormal based on the inspection ejection performed again.

15. The three-dimensional printing device according to claim 14, wherein the controller is configured or programmed to include:
a number of times input to which an upper limit of the number of times of cleaning is input; and
a warning generator that issues a warning when a number of times of cleaning has reached the upper limit.

16. The three-dimensional printing device according to claim 1, wherein
the controller is configured or programmed to include a frequency input to which a frequency of the inspection ejection is input; and
the inspection ejector causes the inspection ejection to be performed at the frequency that is input to the frequency input.
